(19) United States
(12) Patent Application Publication
(10) Pub. No.: US 2012/0198807 A1
(43) Pub. Date: Aug. 9, 2012

(54) BLADE WITH DEBRIS DISBURSING AIR LIFT

(75) Inventor: Matthew Upham, Lee's Summit, MO (US)

(73) Assignee: BLOUNT, INC., Portland, OR (US)

(21) Appl. No.: 13/366,017

(22) Filed: Feb. 3, 2012

Related U.S. Application Data
(60) Provisional application No. 61/439,691, filed on Feb. 4, 2011.

(51) Int. Cl. A01D 34/13

(52) U.S. Cl. 56/289

(57) ABSTRACT

Various embodiments may include a lawn mower blade having a central portion configured to be mounted to an axis of a rotary lawn mower. The blade may further include at least one air lift disposed on an inner portion of the blade, between the central portion and an end portion. The end portion adjacent the air lift may be substantially flat (e.g., flat over a width of the blade). The air lift may angle upwardly from the cutting plane as the air lift moves away from the cutting edge.

### CROSS REFERENCE TO RELATED APPLICATIONS

The present application claims priority to U.S. Provisional Patent Application No. 61/439,691, filed Feb. 4, 2011, entitled “Blade with Shielded Air Lift,” the entire disclosure of which is hereby incorporated by reference in its entirety.

### TECHNICAL FIELD

Embodiments herein relate to the field of lawn mower blades, and, more specifically, to lawn mower blades with one or more air lifts.

### BACKGROUND

Lawn mower blades are widely used in rotary lawn mowers to cut grass. Rotary lawn mower blades typically have a generally rectangular shape with a hole through the center for mounting to the vertical axle of the lawn mower. The blade generally includes cutting edges on opposite sides of each end of the blade. Additionally, many lawn mower blades include an angled portion on the rear edge, called an air lift, which creates an upward air flow as the blade rotates. The air lift typically spans only part of the length of the blade and extends to the end of the blade. The upward air flow caused by the air lift makes the grass to stand up straighter, which increases the effectiveness of the cutting edge. Additionally, the upward air flow helps clear the clippings from the blade after the grass is cut. This reduces clogging of the blade and also draws the clippings toward the bagging element (if present) of the lawn mower.

However, the air lift and the centrifugal force of the blade push the air flow to the ends of the blade. As such, the air lift is subject to considerable wear, especially when the lawn mower is used in areas with loose debris in the soil, such as sand. The pattern of air flow of a typical air lift causes the air lift to wear from the outside edge inward. Furthermore, because of the air flow, only the ends of the cutting edge are utilized for cutting grass. Thus, the inward portions of the cutting edge are not utilized, and the cutting edge wears from the outside edge inward.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIGS. 1A-1E illustrate various views of a blade with a debris disbursing air lift, including: A) a top view; B) a side view; C) a bottom view; D) a front view; and E) a perspective view, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

In various embodiments, methods, apparatuses, and systems for a blade with debris disbursing air lift are provided.

Various embodiments may include a lawn mower blade (also referred to as a blade bar) having a central portion configured to be mounted to an axis of a rotary lawn mower. The blade may further include at least one air lift disposed on an inner portion of the blade, between the central portion and an end portion. The end portion has at least one edge and an upper surface differentiated from the air lift. The end portion adjacent the air lift may be substantially flat (e.g., flat over a width of the blade).

In various embodiments, the blade may be generally rectangular, although other shapes are possible. The blade may include a first end portion and a second end portion disposed on opposite sides of the central portion. The blade may further include a first inner portion and a second inner portion disposed between the respective end portions and the central portion. On at least one side of the mounting hole, the blade may include a cutting edge along a leading edge for cutting grass. In use, the cutting edge may travel in a cutting plane as the blade rotates around the mounting hole. In various embodiments, at least one of the first end portion and second end portion may be substantially flat. In some embodiments, an upper surface of the flat end portion may be at an angle of between −10 and 30 degrees from the cutting plane, such as substantially parallel to the cutting plane. At least one of the first inner portion and second inner portion may include an air lift adjacent to the respective flat end portion. The air lift may slope upwardly from the cutting plane as the air lift moves away from the cutting edge.

In various embodiments, the upward angle of the air lift may create an upward air flow above the top surface of the blade. The upward air flow may cause the grass to stand up, improving the effectiveness of the cut. Additionally, the upward air flow may prevent clogging of the blade, for example by encouraging the cut grass to move clear of the blade after it is cut. Furthermore, the upward air flow may draw the cut grass toward a bagging element of the lawn mower, if a bagging element is present.

In various embodiments, having the air lift disposed away from the end of the blade and the flat portion on the end of the blade may create a channel of air flow at the end of the blade. Additionally, the centrifugal force exerted by the rotation of the blade may cause the air to push toward the outside ends of the blade. The presence of the flat end portion may cause sand and other debris to be channeled around the air lift, decreasing the amount of wear on the air lift. Similarly, the channel of air flow may cause sand and other debris to flow around the blade, decreasing the wear on the blade. Additionally, in a mower that includes multiple blades, the channel of air flow created by the air lift may allow some of the debris to drop back to the ground instead of being thrown from one blade to another blade.

Furthermore, the air flow provided by the blade with the air lift on the inner portion of the blade may allow more of the cutting edge to be effective for cutting than a blade with an air lift that extends to the end of the blade. That is, the portion of the cutting edge near the inner portion and central portion of the blade may be more effective for cutting grass during use. This may cause the blade to wear more evenly across the length of the cutting edge and extend the useful life of the blade.

In some embodiments, the blade may further include one or more gaps adjacent the air lifts. For example, the blade may include a first gap that longitudinally separates a distal end (e.g., further from the central portion) of the air lift from the end portion of the blade and/or a second gap that longitudinally separates a proximal end (e.g., closer to the central portion) of the air lift from the central portion of the blade. The gaps may facilitate the air flow and/or facilitate clearing of debris. Other embodiments of the blade may not include gaps adjacent the air lifts or may only include one of the first gap or the second gap.

In various embodiments, the air lift may be of any suitable type. For example, the air lift may be a relatively high air lift to improve clearing and/or bagging of grass clippings. In other embodiments, the air lift may be a relatively low air lift, which may last longer than a high air lift due to lower wear. In yet other embodiments, the air lift may be a mulching air lift. For instance, the air lift may include one or more teeth, e.g., notches, to improve mulching and/or clearing of the grass clippings.

In some embodiments, each side of the blade may include an end portion that is substantially flat and an air lift disposed on the inner portion of the blade, adjacent the flat end portion. In other embodiments, only one side of the blade may include an air lift disposed on an inner portion of the blade. In these embodiments, the other side may not include an air lift or may include an air lift that extends all the way to the end of the blade.

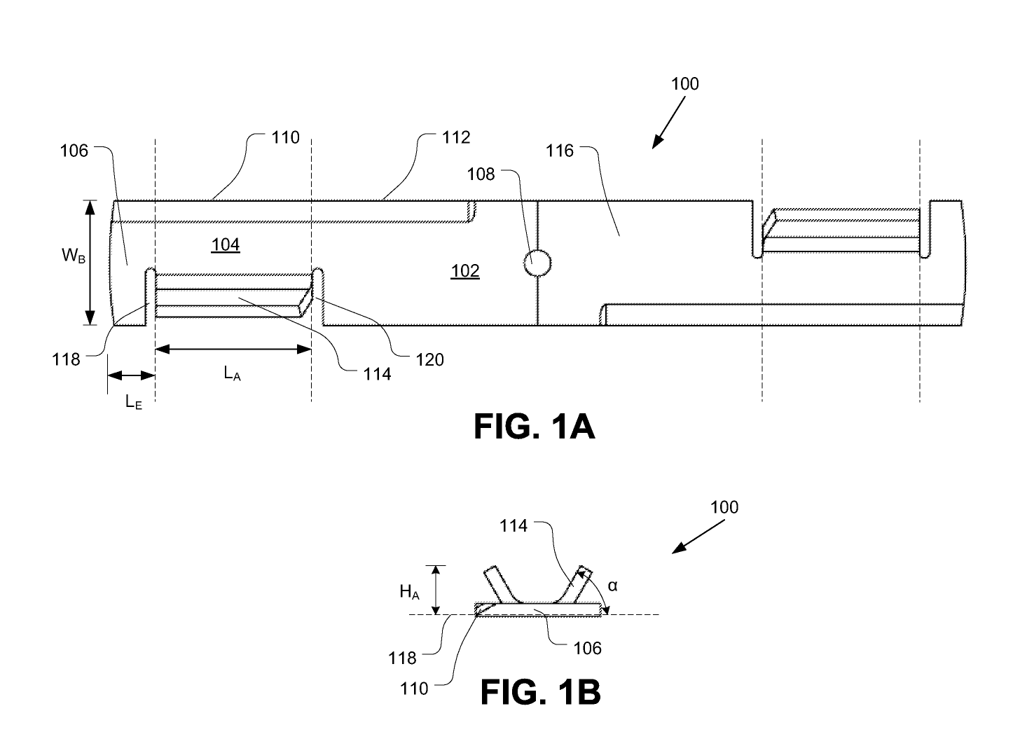

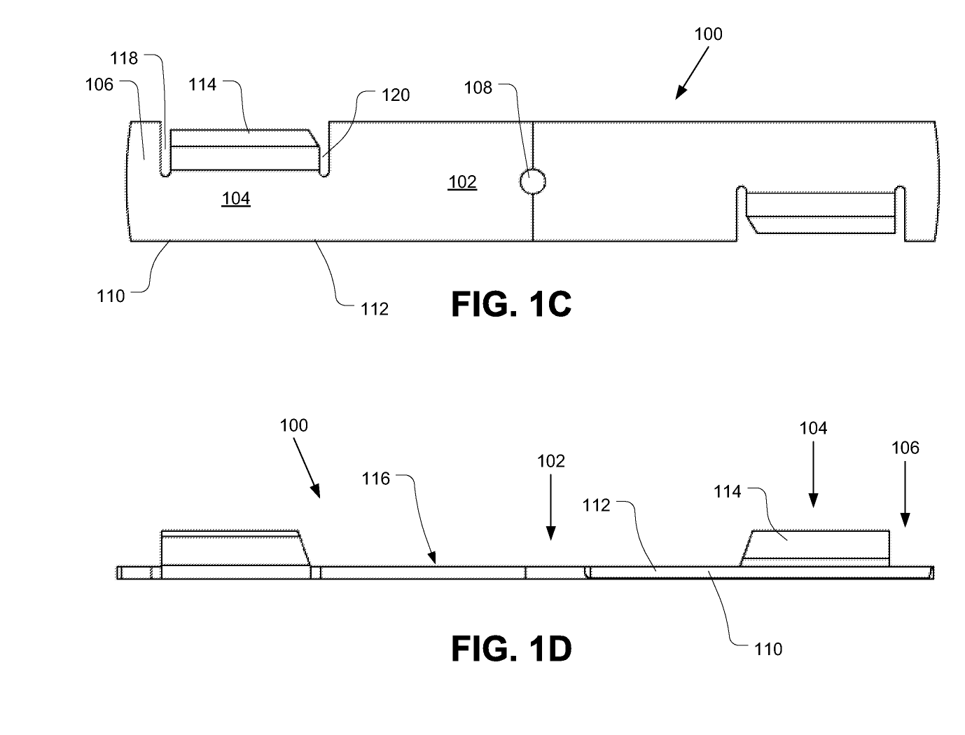

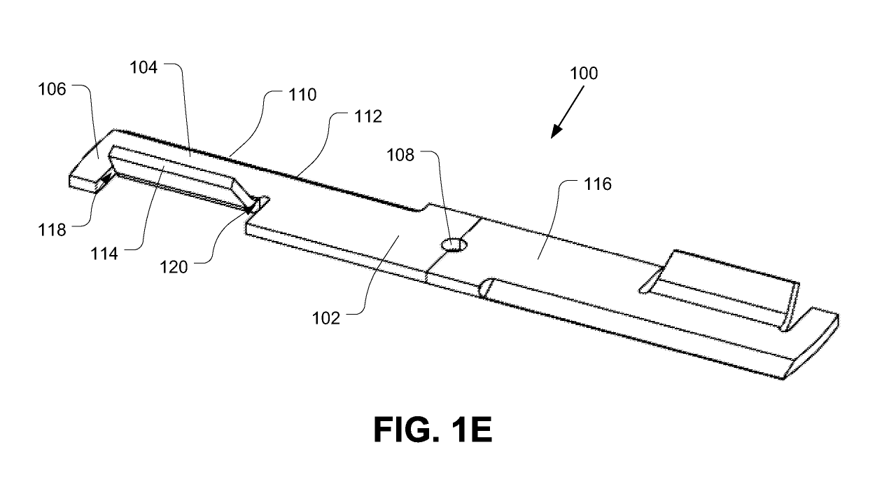

FIGS. 1A-E illustrate an example of a blade 100 configured to be used with a rotary lawnmower, in accordance with various embodiments. As shown in FIG. 1A, the blade 100 includes a central portion 102, inner portions 104, and end portions 106. The central portion 102 of blade 100 includes a mounting hole 108 for mounting the blade to an axis of a rotary lawn mower (not shown). The blade 100 further includes a cutting edges 110 disposed on leading edges 112 of the blade 100, on opposite sides of the mounting hole 108. Additionally, blade 100 includes air lifts 114 disposed on inner portions 104 of the blade 100. The end portions 106 are substantially flat along a width (W_{B}) of the blade. An upper surface 116 of the blade 100 is substantially coplanar over the blade 100, except for the air lifts 114 and cutting edges 110.

When blade 100 is in use, the rotary lawn mower may rotate the blade about the mounting hole 108, causing the cutting edges 110 to travel in a cutting plane 118 (as shown in FIG. 1B). The air lifts 114 are angled upward from the cutting plane 118 and away from the respective cutting edge 110. The blade 100 may be mounted perpendicularly to the ground so that the upper surface 116 of the blade 100 is substantially parallel to the cutting plane 118. In other embodiments, the blade 100 may be mounted at an angle with respect to the ground.

The air lifts 114 may create an upward air flow as blade 100 rotates around mounting hole 108. The air lifts 114 may cooperate with the flat end portions 106 to create a channel of air flow over the end portions 106. The channel of air may prevent sand and/or other debris from contacting the air lifts 114, thereby reducing wear on the air lifts 114. Similarly, the channel of air flow may cause sand and other debris to flow over a greater portion of the length of the cutting edges 110, decreasing wear on the cutting edges 110. Additionally, the channel of air flow may allow some of the debris to drop back to the ground instead of being thrown from one blade to another blade in a multi-blade mower. Furthermore, the channel of air flow may allow a greater portion of the length of the cutting edges 110, to be used to cut grass than a blade with an air lift that extends to the end of the blade. This may cause the blade 100 to wear more evenly across the length of the cutting edges 110 and extend the useful life of the blade 100.

The blade 100 further includes a first gap 118 that longitudinally separates a distal end of the air lift 114 from the end portion 106 of the blade 100 and a second gap 120 that longitudinally separates a proximal end of the air lift 114 from the central portion 102 of the blade 100. The gaps 118 and 120 may contribute to the air flow and/or facilitate clearing of debris. Other embodiments of the blade 100 may not include a first gap 118 or second gap 120, or may only include one of the first gap 118 or the second gap 120.

In various embodiments, air lifts 114 may have a length, L_{A}, along blade 100 as shown in FIG. 1A (e.g., the portion of the overall length of the blade 100 occupied by the air lift 110). Additionally, as shown in FIG. 1B, the air lift may have a height, H_{A}, above the cutting plane 118, and may define an angle, α, with respect to the cutting plane 118 and/or the ground plane. Furthermore, the end portion 106 may have a length, L_{E}, between the end (terminal edge) of the blade and the air lift.

In various embodiments, the air lift 114 may have any suitable length, height, and angle. For example, in some embodiments, the length (L_{A}) of the air lift 114 may be from about 0.5 inches to about 12 inches, such as about 2 inches to about 6 inches wide. The height (H_{A}) of the air lift may be from about 0.1 inches to about 3 inches, such as about 0.5 to about 2 inches high. Additionally, the angle (α) of the air lift with respect to the cutting plane 118 and/or ground plane may be from about 5 degrees to about 90 degrees, such as about 20 degrees to about 80 degrees, for example 45 degrees to about 75 degrees. In one embodiment, the angle (α) may be about 60 degrees. Furthermore, in various embodiments, the flat end portion 106 of the blade 100 may have any suitable length (L_{E}) from the end edge of the blade 100 to the distal end of the air lift. For example, in some embodiments, the flat end portion 106 may have a length (L_{E}) of about 0.1 inches to about 6 inches, such as about 0.5 inches to about 3 inches, or more particularly about 2 inches to about 3 inches.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A lawn mower blade, comprising:
a blade bar having a central portion configured to be mounted to a lawn mower, an end portion, and an inner portion disposed between the end portion and the central portion;
a cutting edge disposed on a leading edge of the blade; and
an air lift on the inner portion, the air lift angled upward and away from the cutting edge.

2. The lawn mower blade of claim 1, wherein the end portion is substantially flat over a width of the blade.

3. The lawn mower blade of claim 2, wherein an upper surface of the end portion is substantially parallel to a cutting plane of the blade.

4. The lawn mower blade of claim 1, wherein the end portion comprises a first end portion, the inner portion comprises a first inner portion, and the air lift comprises a first air lift, and the blade further comprising:
a second end portion opposite the first end portion, the second end portion being substantially flat over a width of the blade;
a second inner portion disposed between the second end portion and the central portion, the second inner portion including a second air lift.

5. The lawn mower blade of claim 1, wherein the blade bar is substantially rectangular.

6. The lawn mower blade of claim 1, wherein the end portion has a length of about 0.5 inches to about 3 inches.

7. The lawn mower blade of claim 1, wherein the air lift has an angle with respect to the cutting plane of about 20 degrees to about 80 degrees.

8. The lawn mower blade of claim 1, wherein the air lift has an angle with respect to the cutting plane of about 45 degrees to about 75 degrees.

9. The lawn mower blade of claim 1, further comprising a gap that longitudinally separates a distal end of the air lift from the end portion of the blade bar.

10. The lawn mower blade of claim 9, wherein the gap comprises a first gap, and the blade further comprising a second gap that longitudinally separates a proximal end of the air lift from the central portion of the blade bar.

11. A lawn mower blade, comprising:
a central portion configured to be mounted to a lawn mower;
a first cutting edge and a second cutting edge disposed on opposite sides of the central portion;
a first air lift disposed on a first inner portion of the blade, the first air lift separated from a first end edge of the blade by a first end portion;
a second air lift disposed on a second inner portion of the blade opposite the central portion from the first inner portion of the blade, the second air lift separated from a second end edge of the blade by a second end portion;
wherein the first and second air lifts are angled upward from a cutting plane of the blade.

12. The lawn mower blade of claim 11, wherein the first and second end portions are substantially flat over a width of the blade.

13. The lawn mower blade of claim 12, wherein respective upper surfaces of the first and second end portions are substantially parallel to the cutting plane.

14. The lawn mower blade of claim 11, wherein the blade bar is substantially rectangular.

15. The lawn mower blade of claim 11, wherein the first end portion has a length of about 0.5 inches to about 3 inches.

16. The lawn mower blade of claim 11, wherein the first air lift has an angle with respect to the cutting plane of about 45 degrees to about 75 degrees.

17. The lawn mower blade of claim 11, further comprising a gap that longitudinally separates a distal end of the first air lift from the first end portion of the blade.

18. The lawn mower blade of claim 17, wherein the gap comprises a first gap, and the blade further comprising a second gap that longitudinally separates a proximal end of the first air lift from the central portion of the blade bar.
